(19) United States
(12) Patent Application Publication
(10) Pub. No.: US 2025/0097819 A1
(43) Pub. Date: Mar. 20, 2025

(54) Establishing Integrated Access and Backhaul Connections

(71) Applicant: Telefonaktiebolaget LM Ericsson (publ), Stockholm (SE)

(72) Inventors: Henrik Ronkainen, Södra Sandby (SE); Paolo Debenedetti, Genova (IT); Nipun Sharma, New Delhi (IN); Daniele Ceccarelli, Sollentuna (SE)

(21) Appl. No.: 18/390,640

(22) PCT Filed: Jul. 8, 2021
(86) PCT No.: PCT/EP2021/069086

§ 371 Date: Dec. 20, 2023

(51) Int. Cl. H04W 40/24; H04W 40/12; H04W 74/0833

(52) U.S. Cl. CPC H04W 40/246; H04W 40/12; H04W 74/0833

(57) ABSTRACT

According to an aspect there is provided a method of operating a first radio access network, RAN, node in a transport network, TN, of a communication network. The TN is for conveying backhaul data between a plurality of RAN nodes, and the RAN nodes provide a radio access network for wireless devices to use to access the communication network. The method in the first RAN node comprises performing (1501) a discovery procedure to identify one or more other RAN nodes in the plurality of RAN nodes with which an Integrated Access and Backhaul, IAB, connection can be established; preparing (1503) respective configurations for LAB counectious between the first RAN node and the identified one or more other RAN nodes; if a failure occurs in a first TN connection between two RAN nodes, establishing (1505) one or more of the IAB connections according to the respective prepared configuration; and using (1507) the established one or more IAB connections in place of, or in addition to, the first TN connection to convey backhaul

### TECHNICAL FIELD

This disclosure relates to the use of integrated access and backhaul, IAB, connections in a communication network, and in particular to the use of IAB connections to convey backhaul data between radio access network (RAN) nodes.

### BACKGROUND

Transport networks (TNs) play a vital role in radio access networks (RANs) by connecting all the components of the RAN together. The use of so-called “dark fibre” for 5^{th} Generation (5G) transport networks is of growing importance and it is considered that wireless backhaul connections are a useful complement for sites where optical fibres are either not available, or are too costly to install and/or use. In fact, ‘microwave backhaul’ has been the dominant global backhaul media for over two decades and will remain a highly attractive complement to optical fibre for 5G transport networks.

Access spectrum has historically been too valuable and limited to use for backhaul data. Its rare use today is for Long Term Evolution (LTE) solutions that provide a single backhaul hop using a different frequency band to that used by wireless devices (also known as User Equipments—UEs) to access the network.

A solution known as Integrated Access and Backhaul (IAB) was studied for LTE in the 3^{rd} Generation Partnership Project (3GPP) Release 10 in 2011, which is also known as “LTE relaying”, but it didn't gain any particular commercial interest. However, with wide millimetre-wave (mmWave) bandwidths now becoming available, there is increasingly interest in an IAB solution for 5G New Radio (NR).

As described in 3GPP TR 38.874 v16.0.0 (“Study on Integrated Access and Backhaul”), one of the potential technologies targeted to enable future cellular network deployment scenarios and applications is the support for wireless backhaul and relay links enabling a flexible and very dense deployment of NR cells without the need for proportionately densifying the wired transport network. The expected larger bandwidth available for NR compared to LTE (e.g. in the mmWave spectrum), along with the native deployment of massive multi-input, multiple output (MIMO) or multi-beam systems in NR creates an opportunity to develop and deploy integrated access and backhaul (IAB) links. In other words, this means that the same spectrum and radio access technology (i.e. the NR Uu interface) can be used both in the wireless backhaul link between access nodes and in the access link between access nodes and User Equipment (UE).

FIG. 1 illustrates the IAB high-level architecture in a 5G network. This figure is based on FIG. 5.35.1-1 of 3GPP TS 23.501 v16.2.0. The 5G network comprises a 5G core (5GC) network 102, and a radio access network, NG-RAN 104 that comprises a number of RAN nodes, gNBs 106a-d. The NG-RAN 104 provides the access network to enable UEs 108 to access the 5G network. The first gNB 106a and the second gNB 106b have a wired connection to the 5GC network 102. The third gNB 106c and the fourth gNB 106d have IAB wireless backhaul connections to the second gNB 106b. The second gNB 106b is referred to as an “IAB Donor” or “donor node” and the gNBs 106c, 106d using the wireless backhaul are referred to as “IAB nodes”. As shown in FIG. 1, the IAB donor 106b and all IAB nodes 106c, 106d may support access links to UEs 108. Furthermore, the wireless backhaul link (IAB) is not limited to carrying NR UE traffic, and other data may be transferred as well, such as data to/from any collocated equipment connected to the IAB node.

The IAB Donor is a logical node that provides the NR-based wireless backhaul which can be a fully integrated gNB (e.g. gNB 106b), or it may use a split architecture consisting of one central unit (CU) 110 and one or more wire-connected donor distributed units (DUs) 112. It is also possible to split the CU into discrete CUs for control plane (CP) and user plane (UP) signalling, as described in “NG-RAN, Architecture Description”, 3GPP TS 38.401 v16.2.0, and as shown in FIG. 2. FIG. 2 shows a gNB 202 that comprises a CU for the control plane, gNB-CU-CP 204, one or more CUs for the user plane, gNB-CU-UP 206, and two gNB-DUs 208.

Each IAB node 106c and 106d contains a DU function 114 and an IAB-Mobile Termination (MT) function 116. The DU 114 in the IAB node 106c, 106d is responsible for providing NR Uu access to UEs and any ‘child’ IAB nodes of the IAB node 106c, 106d (see FIG. 3 below for multi-hop backhaul). The IAB-MT function 116 behaves as a UE, and reuses UE procedures to connect to the gNB-DU 112, 114 in a ‘parent’ IAB-node for access and backhauling. The IAB-MT function 116 can also reuse UE procedures to connect to the gNB-CU 110 in the IAB-donor 106b via radio resource control (RRC) signalling for control of the access and backhaul link. The IAB-MT function 116 can also reuse UE procedures to connect to the 5GC 102 via non-access stratum signalling.

FIG. 3 is an illustration of the use of multi-hop backhauling in which three RAN nodes are connected in a chain using IAB connections. A first RAN node 302 operates as a donor node and has an IAB connection 303 to a second RAN node 304, which itself has an IAB connection 305 to a third RAN node 306. Each RAN node 302, 304, 306 provides radio access to one or more UEs 308. The IAB donor node 302 provides a wired interface 310 to the core network and provides wireless backhauling functionality to IAB nodes 304, 306. The IAB nodes 304, 306 support wireless access to UEs 308 and wirelessly backhaul the access traffic. The IAB connections 303, 305 are also referred to as “IAB links” or “backhaul links”.

The functionality of the two RAN nodes at the endpoints of each IAB connection 303, 305 differs. Thus, from the perspective of the IAB connections 303, 305 they take different roles, either as a parent or a child, where the parent node (topology wise) is closest to the wired backhaul at the network side. Multi-hop backhauling is supported which implies that a particular IAB node may have both roles as it is connected to more than one IAB link. In the example of FIG. 3, the IAB donor node 302 acts as a parent node to the second RAN node 304 (child node), and the second RAN node 304 acts as a parent node to the third RAN node 306 (child node). The second RAN node 304 is therefore referred to as a transit node which is capable of relaying traffic to the next RAN node in the chain. All the RAN nodes 302, 304, 306 may serve UEs 308 over their access link. As the RAN nodes 302, 304, 306 may transmit/receive data to/from either UEs 308 or IAB nodes (even at the same time instant) there is a need to distinguish between the two cases. For this purpose, in addition to downlink (DL) and uplink (UL) which refer to the direction of transmissions on the wireless access links, the terms ‘downstream’ and ‘upstream’ are used to refer to backhaul traffic from the core network, and to the core network, respectively.

The DU 112, 114 in a parent IAB node is typically responsible for scheduling downstream and upstream backhaul traffic to/from the IAB-MT 116 in any child IAB nodes.

RAN node(s) 306 that are at least one IAB connection ‘hop’ from the wired connection 310 to the core network can be described as ‘leaf’ nodes, or as being ‘peripheral’ to other RAN nodes that have less or no IAB connection hops to the wired connection 310.

The introduction of new wide high band (mmWave) spectrum in 5G enables large capacity and very high bitrates. A consequence of the poorer propagation characteristics associated with using high band spectrum is the need for a very dense site deployment to achieve full coverage. The high band deployments are typically in urban areas with high capacity demands, using street sites with dedicated (dark) fibre transport solutions for backhaul. The physical transport network may be shared and cascaded between sites. Thus, a loss or failure of the physical transport network may affect not only one site, but several sites sharing the same fibre or other transport equipment.

In current state-of-art solutions, IAB is normally used to reach sites that cannot be supported via traditional transport networks that use optical fibre or microwave links.

### SUMMARY

A problem with the existing solutions is that IAB and backhaul in a transport network (TN) that uses an optical fibre network or dedicated microwave spectrum are seen as alternative backhaul infrastructure solutions and there is no mechanism to let them interoperate with each other, or to configure the two different transport solutions so that they protect each other or enable offload of traffic from one to the other. Providing such a mechanism could improve the reliability of backhaul data transmission and guarantee higher availability, and provide a higher probability of meeting a service level defined in a service level agreement (SLA).

In particular, the state-of-art 3GPP standards (for example Release 16 and the upcoming Release 17) do not foresee a method for protecting the transport network backhaul using IAB, or vice versa. In 3GPP TR 38.874 v 16.0.0, the only reference to IAB protection is in Section 7.2.4 which refers to mechanisms for detecting/recovering from backhaul link failure based on Release 15 mechanisms, which are specifically RAN based.

In this disclosure it is considered that transport networks (TNs) that use optical fibres and/or dedicated microwave spectrum for backhaul are the most reliable transport method for RAN backhaul, and these TNs are complemented with IAB as a backup. The use of IAB connections as a backup can provide any of: (i) fail-over connectivity in case of a failure in the TN or maintenance in the TN; (ii) a complement to microwave link connectivity in case of reduced throughput conditions; (iii) extra backhaul traffic capacity in case of congestion in the TN; and (iv) as a last hop connection for unwired radios reducing the number of IAB hops. The techniques provide a backhaul infrastructure where a transport network and IAB support mechanisms to increase densification, reliability and dynamic allocation of resources, and are suitable for highly dense RAN deployments such as street sites.

Having IAB connections as a backup enables the offload of the wireless spectrum from non-critical IAB traffic making IAB advantageous for providing resilience and an emergency fallback method for RAN backhaul. The switch over between IAB and backhaul in the transport network should be fast and smooth in order to minimise any impact on the RAN control plane, synchronisation and eventually the UE data plane. Thus, the techniques provide for the pre-planning of IAB connections to allocate resources for IAB connections.

According to a first aspect, there is provided a method of operating a first RAN node in a TN of a communication network. The TN is for conveying backhaul data between a plurality of RAN nodes, and the RAN nodes provide a radio access network for wireless devices to use to access the communication network. The method in the first RAN node comprises performing a discovery procedure to identify one or more other RAN nodes in the plurality of RAN nodes with which an IAB connection can be established; preparing respective configurations for IAB connections between the first RAN node and the identified one or more other RAN nodes; if a failure occurs in a first IN connection between two RAN nodes, establishing one or more of the IAB connections according to the respective prepared configuration; and using the established one or more IAB connections in place of, or in addition to, the first TN connection to convey backhaul data.

According to a second aspect, there is provided a method of operating a control node in a communication network. The communication network comprises a TN for conveying backhaul data between a plurality of RAN nodes, and the RAN nodes provide a radio access network for wireless devices to use to access the communication network. The method in the control node comprises initiating a discovery procedure by at least a first RAN node in the plurality of RAN nodes to identify one or more other RAN nodes in the plurality of RAN nodes with which an IAB connection can be established; and preparing respective configurations for IAB connections between the first RAN node and the identified other RAN nodes, wherein the respective configurations are for use in establishing one or more respective IAB connections between the first RAN node and the identified other RAN nodes in the event of a failure in a first TN connection in the TN.

According to a third aspect, there is provided a computer program product comprising a computer readable medium having computer readable code embodied therein, the computer readable code being configured such that, on execution by a suitable computer or processor, the computer or processor is caused to perform the method according to the first aspect, the second aspect, or any embodiment thereof.

According to a fourth aspect, there is provided a first RAN node for use in a TN of a communication network. The TN is for conveying backhaul data between a plurality of RAN nodes, and the RAN nodes provide a radio access network for wireless devices to use to access the communication network. The first RAN node is configured to perform a discovery procedure to identify one or more other RAN nodes in the plurality of RAN nodes with which an IAB connection can be established; prepare respective configurations for IAB connections between the first RAN node and the identified one or more other RAN nodes; if a failure occurs in a first TN connection between two RAN nodes, establish one or more of the IAB connections according to the respective prepared configuration; and use the established one or more IAB connections in place of, or in addition to, the first TN connection to convey backhaul data.

According to a fifth aspect, there is provided a control node for use in a communication network. The communication network comprises a TN for conveying backhaul data between a plurality of RAN nodes, and the RAN nodes provide a radio access network for wireless devices to use to access the communication network. The control node is configured to initiate a discovery procedure by at least a first RAN node in the plurality of RAN nodes to identify one or more other RAN nodes in the plurality of RAN nodes with which an IAB connection can be established; and prepare respective configurations for IAB connections between the first RAN node and the identified other RAN nodes, wherein the respective configurations are for use in establishing one or more respective IAB connections between the first RAN node and the identified other RAN nodes in the event of a failure in a first TN connection in the TN.

According to a sixth aspect, there is provided a first RAN node for use in a TN of a communication network. The TN is for conveying backhaul data between a plurality of RAN nodes, and the RAN nodes provide a radio access network for wireless devices to use to access the communication network. The first RAN node comprises a processor and a memory, said memory containing instructions executable by said processor whereby said first RAN node is operative to perform a discovery procedure to identify one or more other RAN nodes in the plurality of RAN nodes with which an IAB connection can be established; prepare respective configurations for IAB connections between the first RAN node and the identified one or more other RAN nodes; if a failure occurs in a first TN connection between two RAN nodes, establish one or more of the IAB connections according to the respective prepared configuration; and use the established one or more IAB connections in place of, or in addition to, the first TN connection to convey backhaul data.

According to a seventh aspect, there is provided a control node for use in a communication network. The communication network comprises a TN for conveying backhaul data between a plurality of RAN nodes, and the RAN nodes provide a radio access network for wireless devices to use to access the communication network. The control node comprises a processor and a memory, said memory containing instructions executable by said processor whereby said control node is operative to initiate a discovery procedure by at least a first RAN node in the plurality of RAN nodes to identify one or more other RAN nodes in the plurality of RAN nodes with which an IAB connection can be established; and prepare respective configurations for IAB connections between the first RAN node and the identified other RAN nodes, wherein the respective configurations are for use in establishing one or more respective IAB connections between the first RAN node and the identified other RAN nodes in the event of a failure in a first TN connection in the TN.

The described techniques can provide any one or more of the following advantages.

Radio base station sites on streets are becoming increasingly important for dense urban areas where both optical fibre and IAB can be used to reach the same radio sites to increase availability and resiliency. The described techniques allow for any of: better employment of network resources; increasing revenues due to the possibility to meet more stringent SLAs; and increasing the reliability of the network providing fail-over communication paths for the RAN backhaul traffic. In other words, the techniques allow for advantageously and dynamically sharing the backhaul throughput between Radio and Transport resources in order to optimise and protect the RAN backhaul, and eventually increase the RAN resilience.

Some embodiments provide for the initiation of on-demand activation of IAB as a protection or restoration method for traditional backhaul traffic and therefore manage any emergency scenarios whereas the mid-bands can be dedicated to IAB for RAN recovery over longer distance cells.

Some embodiments allow for the offload of backhaul traffic over IAB connections in case of transport congestion with a dynamic allocation of network slices between Transport and Radio links. This can be advantageously considered as a method to achieve much higher RAN densification and coverage.

Some embodiments provide that the collaboration between the transport network and RAN domains allows the usage of IAB to the last-hop connection to be minimised by dynamically considering the closest cell with transport connectivity instead of pre-allocating the IAB links in advance.

Other benefits and advantages will be apparent to those skilled in the art.

### BRIEF DESCRIPTION OF THE DRAWINGS

Some of the embodiments contemplated herein will now be described more fully with reference to the accompanying drawings, in which:

FIG. 1 illustrates the IAB high-level architecture in a 5G network;

FIG. 2 illustrates the split of central unit functionality for the control plane and user plane;

FIG. 3 illustrates the use of multi-hop backhauling;

FIG. 4 is an example of a communication system;

FIG. 5 is an example of a RAN node in accordance with some embodiments;

FIG. 6 is an example of a control node in accordance with some embodiments;

FIG. 7 is an example of a virtualization environment in accordance with some embodiments;

FIG. 8 is a logical network view of two gNBs split into a respective CUs and multiple DUs;

FIG. 9 illustrates the physical connections provided by a transport network;

FIG. 10 illustrates a failure in the transport network of FIG. 9;

FIG. 11 illustrates another failure in a transport network;

FIG. 12 is a signalling diagram showing the integration of an IAB node in a standalone mode;

FIG. 13 is a flow chart illustrating a method according to various embodiments;

FIG. 14 is a signalling diagram illustrating an IAB failover procedure according to various embodiments;

FIG. 15 is a flow chart illustrating a method of operating a RAN node according to various embodiments; and

FIG. 16 is a flow chart illustrating a method of operating a control node according to various embodiments.

### DETAILED DESCRIPTION

Some of the embodiments contemplated herein will now be described more fully with reference to the accompanying drawings. Other embodiments, however, are contained within the scope of the subject-matter disclosed herein, and the disclosed subject-matter should not be construed as limited to only the embodiments set forth herein; rather, these embodiments are provided by way of example to convey the scope of the subject-matter to those skilled in the art.

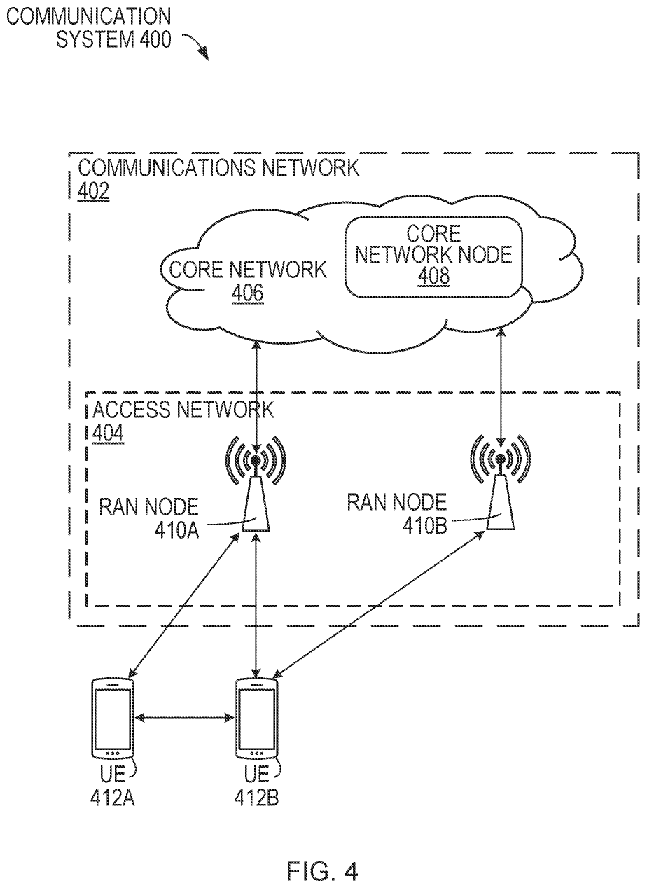

FIG. 4 shows an example of a communication system 400 in which the techniques described herein can be implemented. In the example, the communication system 400 includes a communication network 402 that includes an access network 404, such as a radio access network (RAN), and a core network 406, which includes one or more core network nodes 408. The access network 404 includes one or more ran access network (RAN) nodes, such as RAN nodes 410a and 410b (one or more of which may be generally referred to as RAN nodes 410), or any other similar 3^{rd} Generation Partnership Project (3GPP) access node or non-3GPP access point. The RAN nodes 410 facilitate direct or indirect connection of wireless devices (also referred to interchangeably herein as user equipment (UE)), such as by connecting UEs 412a and 412b (one or more of which may be generally referred to as UEs 412) to the core network 406 over one or more wireless connections. The RAN nodes 410 may be, for example, access points (APs) (e.g. radio access points), base stations (BSs) (e.g. radio base stations, Node Bs, evolved Node Bs (eNBs) and NR NodeBs (gNBs).

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, RAN nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The wireless devices/UEs 412 may be any of a wide variety of communication devices, including wireless devices arranged, configured, and/or operable to communicate wirelessly with the network nodes 410 and other communication devices. Similarly, the RAN nodes 410 are arranged, capable, configured, and/or operable to communicate directly or indirectly with the UEs 412 and/or with other network nodes or equipment in the communication network 402 to enable and/or provide network access, such as wireless network access, and/or to perform other functions, such as administration in the communication network 402.

The core network 406 includes one more core network nodes (e.g. core network node 408) that are structured with hardware and software components. Features of these components may be substantially similar to those described with respect to the wireless devices/UEs, and/or RAN nodes, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

As a whole, the communication system 400 of FIG. 4 enables connectivity between the wireless devices/UEs and RAN nodes. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the communication network 402 is a cellular network that implements 3GPP standardized features. Accordingly, the communication network 402 may support network slicing to provide different logical networks to different devices that are connected to the communication network 402. For example, the communication network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

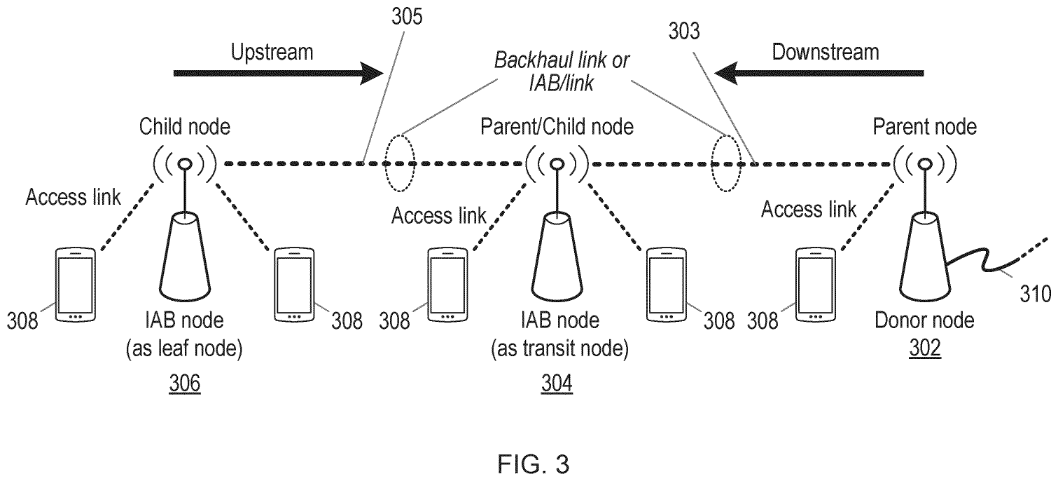

FIG. 4 shows the logical connections of the two RAN nodes 410a and 410b to the core network 406. However, in practice, the RAN nodes 410 can be connected to the core network 406 via a transport network (TN), in the form of an optical fibre network or a dedicated microwave band wireless connection. The TN provides the physical connection between the access network 404 and the core network 406. As noted above with respect to FIG. 3, the TN can connect a first RAN node, e.g. RAN node 410a, to the core network 406, and the TN can connect a second RAN node, e.g. RAN node 410b, to the first RAN node 410a, with the backhaul traffic for the second RAN node 410b passing to/from the core network 406 via the first RAN node 410a.

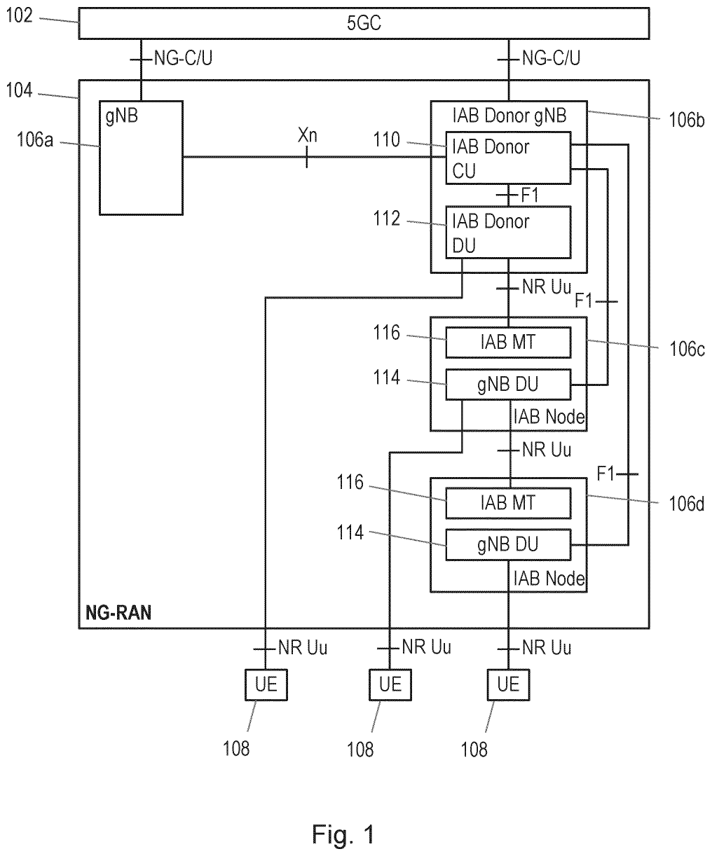

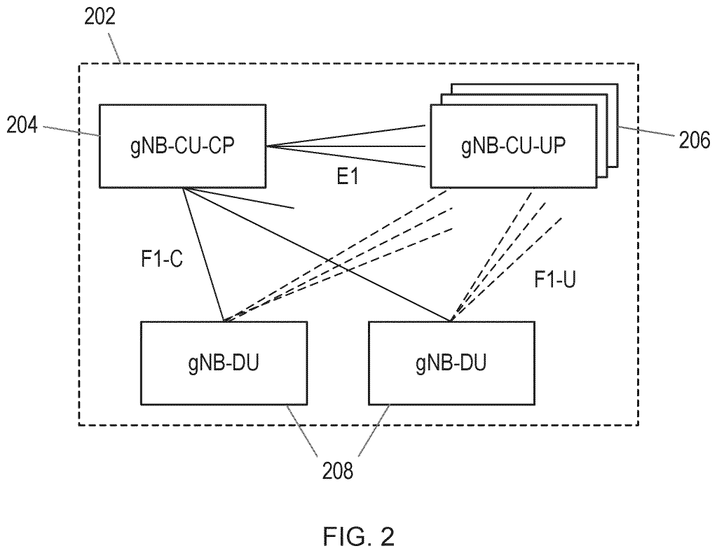

Any of the RAN nodes 410 in the access network 404 can be configured, or be configurable, to operate as an IAB donor node in an IAB architecture (e.g. as shown in FIG. 1). In this case, the RAN node(s) 410 can be considered to be, or to be capable of operating as, a central unit (CU) in an IAB architecture. In addition or alternatively, any of the RAN nodes 410 in the access network 404 can be configured, or be configurable, to operate as an IAB node in an IAB architecture (e.g. as shown in FIG. 1). In this case, the RAN node(s) 410 can be considered to be, or to be capable of operating as, a distributed unit (DU) in an IAB architecture.

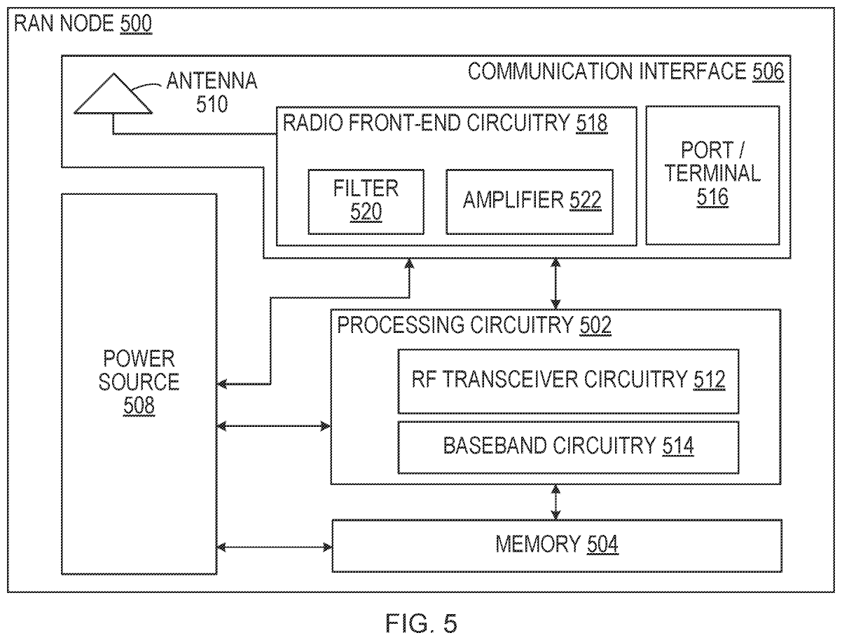

FIG. 5 shows a RAN node 500 in accordance with some embodiments. As used herein, ‘RAN node’ refers to equipment capable, configured, arranged and/or operable to communicate directly or indirectly with a UE and/or with other RAN nodes or equipment, in a communication network. Such communications with other RAN nodes include IAB connections. Examples of RAN nodes include, but are not limited to, RAN nodes such as access points (APs) (e.g. radio access points), base stations (BSs) (e.g. radio base stations, Node Bs, evolved Node Bs (eNBs) and NR NodeBs (gNBs).

As noted above, the RAN node 500 can be configured or configurable to operate as a distributed unit (DU) in an IAB architecture. In some embodiments, the RAN node 500 may also be configured or configurable to operate as a central unit (CU) in an IAB architecture.

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A RAN node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of RAN nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs)), and/or Minimization of Drive Tests (MDTs).

The RAN node 500 includes processing circuitry 502, a memory 504, a communication interface 506, and a power source 508, and/or any other component, or any combination thereof. The RAN node 500 may be composed of multiple physically separate components (e.g. a NodeB component and a RNC component, or a BTS component and a BSC component, etc.), which may each have their own respective components. In certain scenarios in which the RAN node 500 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the RAN node 500 may be configured to support multiple radio access technologies (RATs). In such embodiments, some components may be duplicated (e.g. separate memory 504 for different RATs) and some components may be reused (e.g. a same antenna 510 may be shared by different RATs). The RAN node 500 may also include multiple sets of the various illustrated components for different wireless technologies integrated into RAN node 500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within RAN node 500.

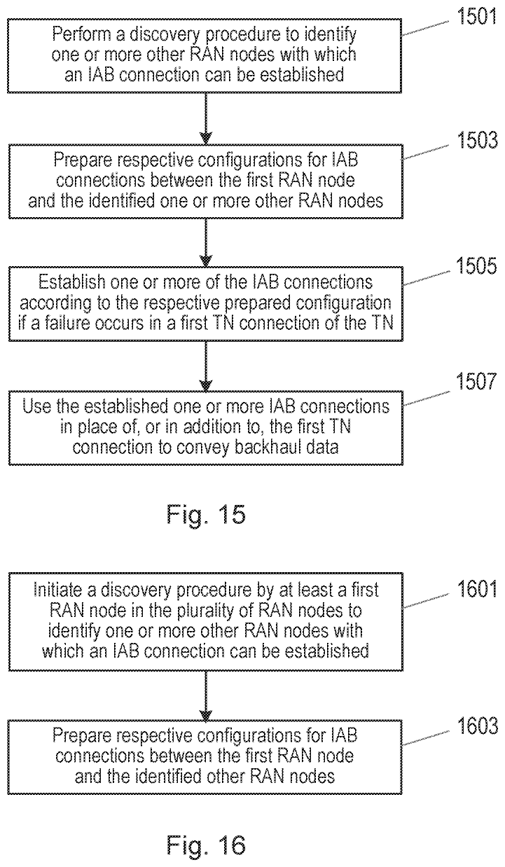

The processing circuitry 502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other RAN node 500 components, such as the memory 504, to provide RAN node 500 functionality. For example, the processing circuitry 502 may be configured to cause the RAN node to perform the methods as described with reference to FIG. 15.

In some embodiments, the processing circuitry 502 includes a system on a chip (SOC). In some embodiments, the processing circuitry 502 includes one or more of radio frequency (RF) transceiver circuitry 512 and baseband processing circuitry 514. In some embodiments, the radio frequency (RF) transceiver circuitry 512 and the baseband processing circuitry 514 may be on separate chips (or sets of chips), boards, or units, such as radio units and digital units. In alternative embodiments, part or all of RF transceiver circuitry 512 and baseband processing circuitry 514 may be on the same chip or set of chips, boards, or units.

The memory 504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 502. The memory 504 may store any suitable instructions, data, or information, including a computer program, software, an application including one or more of logic, rules, code, tables, and/or other instructions capable of being executed by the processing circuitry 502 and utilized by the network node 500. The memory 504 may be used to store any calculations made by the processing circuitry 502 and/or any data received via the communication interface 506. In some embodiments, the processing circuitry 502 and memory 504 is integrated.

The communication interface 506 is used in wired or wireless communication of signalling and/or data between RAN nodes, the access network, the core network, and/or a UE. As illustrated, the communication interface 506 comprises port(s)/terminal(s) 516 to send and receive data. The port(s)/terminal(s) 516 can send and receive data, for example to and from a network over a wired connection, such as optical fibres in a Transport Network. Alternatively or in addition, the port(s)/terminal(s) 516 can send and receive data between RAN nodes wirelessly via IAB connections and/or via a dedicated microwave Transport Network.

The communication interface 506 also includes radio front-end circuitry 518 that may be coupled to, or in certain embodiments a part of, the antenna 510. Radio front-end circuitry 518 comprises filters 520 and amplifiers 522. The radio front-end circuitry 518 may be connected to an antenna 510 and processing circuitry 502. The radio front-end circuitry may be configured to condition signals communicated between antenna 510 and processing circuitry 502. The radio front-end circuitry 518 may receive digital data that is to be sent out to other RAN nodes or UEs via a wireless connection. The radio front-end circuitry 518 may convert the digital data into a radio signal having the appropriate channel and bandwidth parameters using a combination of filters 520 and/or amplifiers 522. The radio signal may then be transmitted via the antenna 510. Similarly, when receiving data, the antenna 510 may collect radio signals which are then converted into digital data by the radio front-end circuitry 518. The digital data may be passed to the processing circuitry 502. In other embodiments, the communication interface may comprise different components and/or different combinations of components.

In certain alternative embodiments, the RAN node 500 does not include separate radio front-end circuitry 518, instead, the processing circuitry 502 includes radio front-end circuitry and is connected to the antenna 510. Similarly, in some embodiments, all or some of the RF transceiver circuitry 512 is part of the communication interface 506. In still other embodiments, the communication interface 506 includes one or more ports or terminals 516, the radio front-end circuitry 518, and the RF transceiver circuitry 512, as part of a radio unit (not shown), and the communication interface 506 communicates with the baseband processing circuitry 514, which is part of a digital unit (not shown).

The antenna 510 may include one or more antennas, or antenna arrays, configured to send and/or receive wireless signals. The antenna 510 may be coupled to the radio front-end circuitry 518 and may be any type of antenna capable of transmitting and receiving data and/or signals wirelessly. In certain embodiments, the antenna 510 is separate from the RAN node 500 and connectable to the RAN node 500 through an interface or port.

The antenna 510, communication interface 506, and/or the processing circuitry 502 may be configured to perform any receiving operations and/or certain obtaining operations described herein as being performed by the RAN node. Any information, data and/or signals may be received from a UE, another RAN node and/or any other network equipment. Similarly, the antenna 510, the communication interface 506, and/or the processing circuitry 502 may be configured to perform any transmitting operations described herein as being performed by the RAN node. Any information, data and/or signals may be transmitted to a UE, another RAN node and/or any other network equipment.

The power source 508 provides power to the various components of RAN node 500 in a form suitable for the respective components (e.g. at a voltage and current level needed for each respective component). The power source 508 may further comprise, or be coupled to, power management circuitry to supply the components of the RAN node 500 with power for performing the functionality described herein. For example, the RAN node 500 may be connectable to an external power source (e.g. the power grid, an electricity outlet) via an input circuitry or interface such as an electrical cable, whereby the external power source supplies power to power circuitry of the power source 508. As a further example, the power source 508 may comprise a source of power in the form of a battery or battery pack which is connected to, or integrated in, power circuitry. The battery may provide backup power should the external power source fail.

Embodiments of the RAN node 500 may include additional components beyond those shown in FIG. 5 for providing certain aspects of the RAN node's functionality, including any of the functionality described herein and/or any functionality necessary to support the subject matter described herein. For example, the RAN node 500 may include user interface equipment to allow input of information into the RAN node 500 and to allow output of information from the RAN node 500. This may allow a user to perform diagnostic, maintenance, repair, and other administrative functions for the RAN node 500.

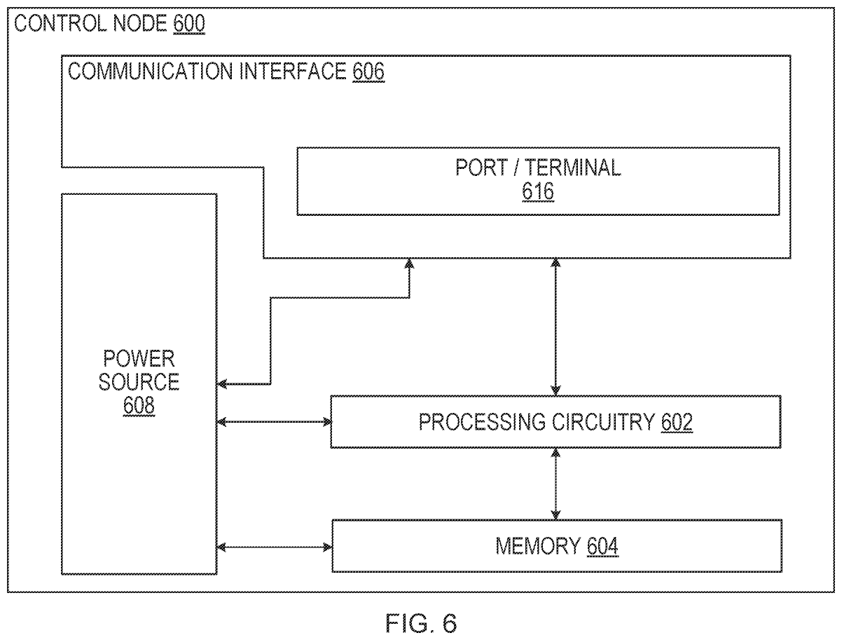

FIG. 6 shows a control node 600 in accordance with some embodiments. The control node 600 can be a central unit (CU) in an IAB architecture. The control node/CU 600 may be part of a RAN node 410, 500, or it may be separate from the RAN nodes 410, 500, for example the control node/CU 600 may be in the form of a server. In this case, the control node/CU 600 may be another node in the access network 404, or a node in the core network 406. The control node/CU 600 is configured to communicate directly or indirectly with one or more RAN nodes, e.g. distributed units (DUs), or equipment, in a communication network. Such communications with DUs are via an F1 interface.

The control node 600 includes processing circuitry 602, a memory 604, a communication interface 606, and a power source 608, and/or any other component, or any combination thereof. The control node 600 may be composed of multiple physically separate components, which may each have their own respective components.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other control node 600 components, such as the memory 604, to provide control node 600 functionality. For example, the processing circuitry 602 may be configured to cause the control node 600 to perform the methods as described with reference to FIG. 16.

In some embodiments, the processing circuitry 602 includes a SOC. In embodiments where the control node is part of a RAN node 410, 500, the processing circuitry 602 can include one or more of RF transceiver circuitry 612 and baseband processing circuitry 614. In some embodiments, the RF transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, RAM, ROM, mass storage media (for example, a hard disk), removable storage media (for example, a flash drive, a CD or a DVD), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the control node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signalling and/or data between the control node 600 and one or more RAN nodes 500/DUs, the access network, and/or the core network. As illustrated, the communication interface 606 comprises port(s)/terminal(s) 616 to send and receive data. The port(s)/terminal(s) 616 can send and receive data, for example to and from a core network or RAN nodes/DUs over a wired connection, such as optical fibres in a Transport Network or a wireless connection, such as a dedicated microwave Transport Network.

The communication interface 606 and/or the processing circuitry 602 may be configured to perform any receiving operations and/or certain obtaining operations described herein as being performed by the control node/CU. Any information, data and/or signals may be received from a DU, a(nother) RAN node and/or any other network equipment. Similarly, the communication interface 606 and/or the processing circuitry 602 may be configured to perform any transmitting operations described herein as being performed by the control node/CU. Any information, data and/or signals may be transmitted to a DU, a(nother) RAN node and/or any other network equipment.

The power source 608 provides power to the various components of control node 600 in a form suitable for the respective components (e.g. at a voltage and current level needed for each respective component). The power source 608 may further comprise, or be coupled to, power management circuitry to supply the components of the control node 600 with power for performing the functionality described herein. For example, the control node 600 may be connectable to an external power source (e.g. the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the control node 600 may include additional components beyond those shown in FIG. 6 for providing certain aspects of the control node's functionality, including any of the functionality described herein and/or any functionality necessary to support the subject matter described herein. For example, the control node 600 may include user interface equipment to allow input of information into the control node 600 and to allow output of information from the control node 600. This may allow a user to perform diagnostic, maintenance, repair, and other administrative functions for the control node 600.

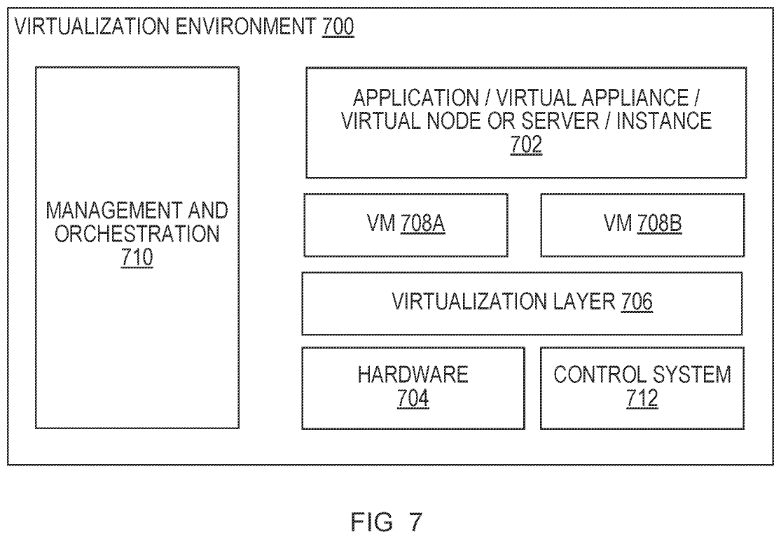

FIG. 7 is a block diagram illustrating a virtualization environment 700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 700 hosted by one or more of hardware nodes, such as a hardware computing device that operates as a RAN node or a control node/CU. Further, in embodiments in which the virtual node does not require radio connectivity (e.g. a control node/CU), then the node may be entirely virtualized.

Applications 702 (which may alternatively be called software instances, virtual appliances, network functions, virtual nodes, virtual network functions, etc.) are run in the virtualization environment 700 to implement some of the features, functions, and/or benefits of some of the embodiments disclosed herein.

Hardware 704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 706 (also referred to as hypervisors or virtual machine monitors (VMMs)), provide VMs 708a and 708b (one or more of which may be generally referred to as VMs 708), and/or perform any of the functions, features and/or benefits described in relation with some embodiments described herein. The virtualization layer 706 may present a virtual operating platform that appears like networking hardware to the VMs 708.

The VMs 708 comprise virtual processing, virtual memory, virtual networking or interface and virtual storage, and may be run by a corresponding virtualization layer 706. Different embodiments of the instance of a virtual appliance 702 may be implemented on one or more of VMs 708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 708 may be a software implementation of a physical machine that runs programs as if they were executing on a physical, non-virtualized machine. Each of the VMs 708, and that part of hardware 704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 708 on top of the hardware 704 and corresponds to the application 702.

Hardware 704 may be implemented in a standalone network node with generic or specific components. Hardware 704 may implement some functions via virtualization. Alternatively, hardware 704 may be part of a larger cluster of hardware (e.g. such as in a data center) where many hardware nodes work together and are managed via management and orchestration 710, which, among others, oversees lifecycle management of applications 702. In some embodiments, hardware 704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN node or a base station. In some embodiments, some signalling can be provided with the use of a control system 712 which may alternatively be used for communication between hardware nodes and radio units.

As noted above, this disclosure proposes the use of IAB as a fallback option in case of a failure in the backhaul transport network. This process involves RAN nodes that are operating as DUs, and a control node such as a CU in a RAN node or elsewhere in the communication network. The process includes allocating IAB resources on demand, and potentially allows for the readjustment of UE policy due to changed conditions.

With this method the control node can pre-empt non-critical UE services to dynamically allocate IAB channels under emergency conditions. Conversely the UE policy for the remaining services is updated in order to fit the available capacity of the IAB link. It is noted this process of dynamically allocating IAB channels is particularly advantageous in the mid-bands where spectrum is a precious resource contended with UE services.

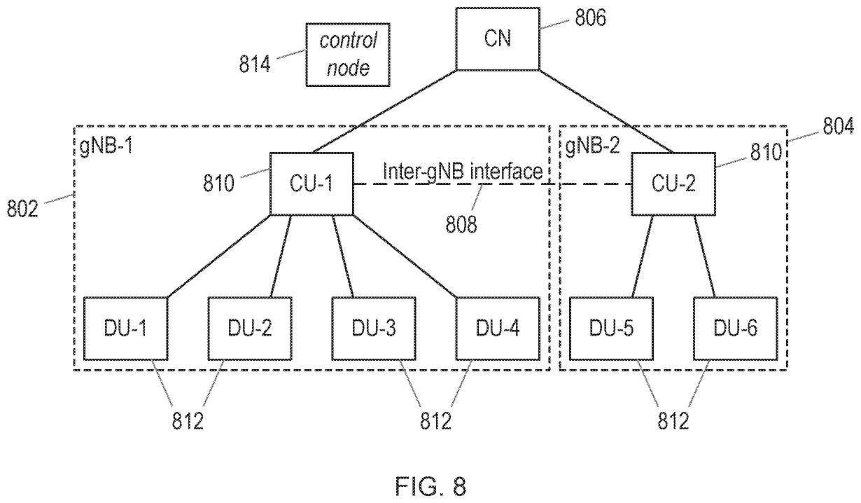

FIG. 8 shows a logical network view of two gNBs split into a respective CUs and multiple DUs. A first gNB 802 (gNB-1) and a second gNB 804 (gNB-2) are shown that are connected to a core network 806. The gNBs 802, 804 can be interconnected via an inter-gNB interface 808, for example an Xn interface. Each of the gNBs 802, 804 comprises a CU 810 (CU-1 and CU-2 respectively) and multiple DUs 812. gNB-1 802 comprises four DUs 812 and gNB-2 804 comprises two DUs 812. A control node 814 is shown for embodiments in which the techniques are implemented using a control node that is separate from the CUs 810 in the gNBs 802, 804.

Backhaul data can be sent to and/or received from any of the CUs 810 and/or DUs 812. Backhaul data can include user data (e.g. user plane data), for example data received from UEs connected to a DU that is to be transferred up to the core network 806 and out of the communication network, e.g. to the Internet. Likewise, backhaul data can be data (e.g. control plane data) received via the core network 806 that is to be sent to UEs connected to a DU. The backhaul data can include control signalling, management data, operating parameters, and/or other essential signalling between any of the DUs, CUs and/or the core network 806 that enable the network to operate. Backhaul data can be any data transferred or conveyed via one of the backhaul interfaces, e.g. the user plane interface NG-U or control plane interface NG-C, between the CU 810 and the core network 806, or the F1 interface between the DU(s) 812 and CU 810.

While FIG. 8 shows the logical connections between the CUS 810 and DUs 812, the physical connections between the nodes/units provided by the transport network that carries the backhaul data may be different to the logical connections.

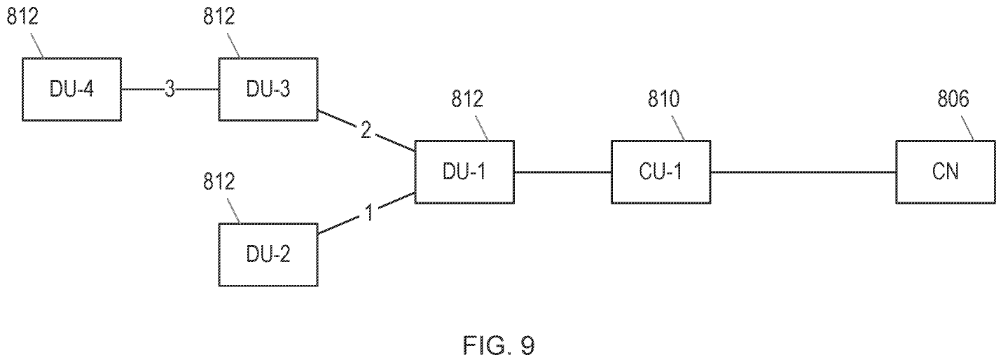

FIG. 9 illustrates an exemplary transport network layout for the first gNB 802 in which the connections are relayed/cascaded by transport network functionality in DU-1 and DU-3. Thus, the transport network (TN) connects DU-1 directly to CU-1 810, and CU-1 810 is connected to the core network 806. The TN connects both DU-2 and DU-3 to DU-1, and DU-4 is connected to DU-3. Thus, all backhaul data for DU-4 passes via DU-3 and DU-1, and all backhaul data for DU-2 passes via DU-1. The TN connection between DU-1 and DU-2 is referred to as ‘TN connection 1’, the TN connection between DU-1 and DU-3 is referred to as ‘TN connection 2’, and the TN connection between DU-3 and DU-4 is referred to as ‘TN connection 3’.

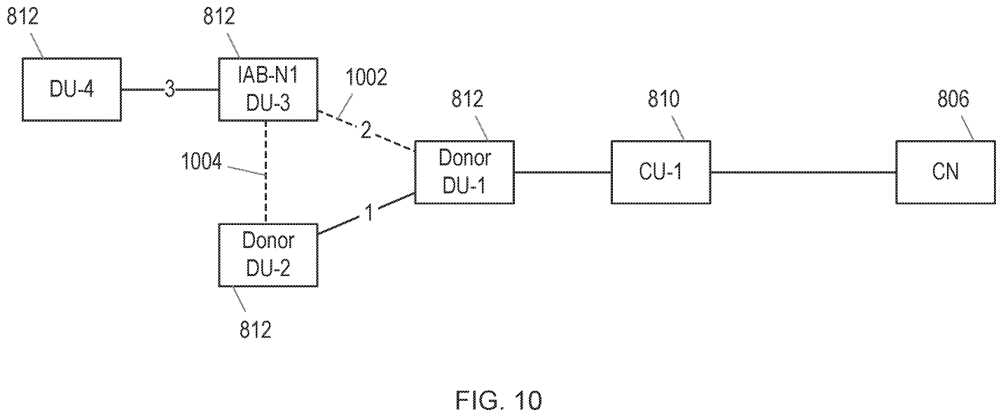

FIG. 10 shows the use of the techniques described herein to address a failure in a connection of the transport network shown in FIG. 9. In particular, there may be a failure in TN connection 2 between DU-1 and DU-3, for example the optical fibre network may be switched off for maintenance, or part of the optical fibre equipment may fail. In this case, the techniques described herein may enable an IAB connection 1002 to be established between DU-1 and DU-3 to bridge the failure in the transport network (or to use the IAB connection in addition to the failed TN connection in case the failure is not total), enabling backhaul data to continue to be sent to and received from DU-3 and DU-4. Here, DU-1 operates as a donor IAB node, and DU-3 is an IAB node. In this case the IAB connection directly replaces failed TN connection 2 (i.e. backhaul data between DU-1 and DU-3 passes through the IAB connection rather than TN connection 2). However, it may be that IAB connection 1002 is not possible or there is a better IAB connection with another DU, for example because of the radio conditions between DU-1 and DU-3, and so alternatively, the techniques may enable an IAB connection 1004 to be established between DU-2 and DU-3 to bridge the failure in the transport network. Here, DU-2 operates as a donor IAB node, and DU-3 is an IAB node. In this case, backhaul data can continue to be sent to and received from DU-3 and DU-4, but now the backhaul data to and from DU-3/4 will pass via the IAB connection 1004 to DU-2 and via TN connection 1 to DU-1. In some cases, both of the IAB connections 1002 and 1004 can be established to bridge the failure in the transport network and be used to convey the backhaul data between DU1 and DU-3. This is possible since F1 is an Internet Protocol (IP)-based interface and can route the backhaul data over different paths.

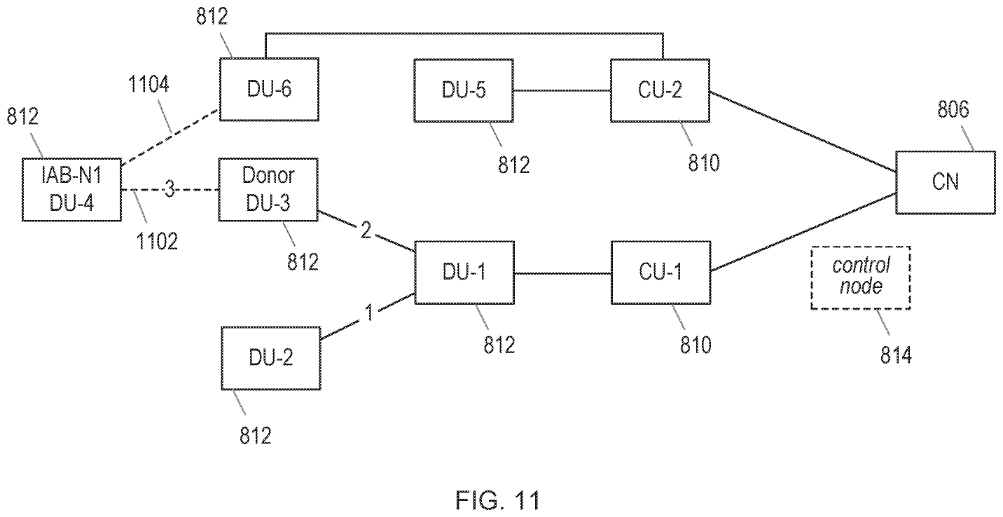

FIG. 11 shows another use of the techniques described herein to address a failure in a connection of the transport network shown in FIG. 9. In addition to the TN shown in FIG. 9, FIG. 11 also shows part of the transport network used to connect the nodes in gNB-2 804 to the core network 806. Thus, the TN connects both DU-5 and DU-6 directly to CU-2 810, and CU-2 810 is connected to the core network 806.

If the event of a failure in TN connection 3 (i.e. between DU-3 and DU-4), the techniques described herein may enable an IAB connection 1102 to be established between DU-3 and DU-4 to bridge the failure in the transport network (or to use the IAB connection in addition to the failed TN connection in case the failure is not total), enabling backhaul data to continue to be sent to and received from DU-4. Here, DU-3 operates as a donor IAB node, and DU-4 is an IAB node. In this case the IAB connection directly replaces failed TN connection 3 (i.e. backhaul data between DU-3 and DU-4 passes through the IAB connection rather than TN connection 3). However, it may be that IAB connection 1102 is not possible or there is a better IAB connection with another DU, for example because of the radio conditions between DU-3 and DU-4, and so alternatively, the techniques may enable an IAB connection 1104 to be established between DU-4 and DU-6 to bridge the failure in the transport network. Here, DU-6 operates as a donor IAB node, and DU-4 is an IAB node. In this case, backhaul data can continue to be sent to and received from DU-4, but now the backhaul data to and from DU-4 will pass via the IAB connection with DU-6, and via CU-2 810 to the core network 806. Thus, even though DU-6 is managed by a different CU 810 to DU-4 in the TN, it is still possible for these DUs to be connected using IAB connections and for backhaul data to be re-rerouted according to the IAB connections that can be established.

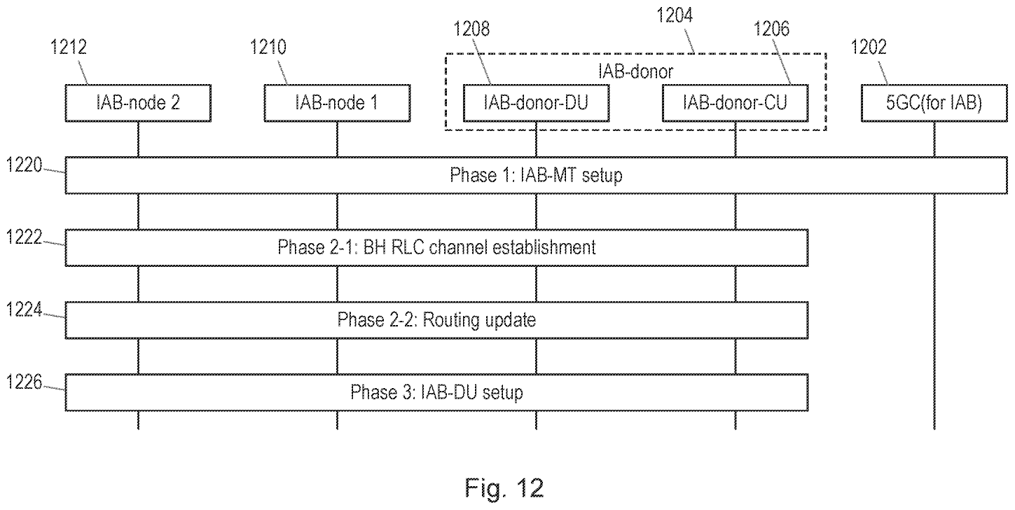

FIG. 12 is a signalling diagram showing the integration of an IAB node in a standalone mode. This signalling diagram is found in “NG-RAN, Architecture Description” (3GPP TS 38.401 v16.2.0) and illustrates the different phases for integration of an IAB node to a standalone (SA) 5G network. FIG. 12 therefore shows the signalling between the 5G core 1202, an IAB donor node 1204 comprising a donor CU 1206 and a donor CU 1206, a first IAB node 1210 and a second IAB node 1212.

Phase 1 (1220) involves the set up of IAB-MT, including MT connectivity and registration with the CU 1206, authentication with the core network 1202, radio bearer configuration (signalling radio bearer (SRB) and dedicated radio bearer (DRB)) and Operations, Administration and Maintenance (OAM) connectivity.

Phase 2 (1222) involves backhaul (BH) Radio Link Control (RLC) establishment, Backhaul Adaptation Protocol (BAP) address assignment and BAP routing identity (ID) for uplink.

Phase 3 (1224) involves Internet Protocol (IP) address configuration and routing updates.

Phase 4 (1226) involves IAB-DU configuration, Transport Network Layer (TNL) establishment and set up of the F1 interface.

The configuration activities shown in FIG. 12 are time consuming which implies that there will be an unnecessarily long service interruption if these activities are executed when a transport network failure occurs. With the aim of minimising the interruption time, IAB connections can be pre-configured to enable a fast establishment of IAB connections in the event of a failure in one or more connections of the TN.

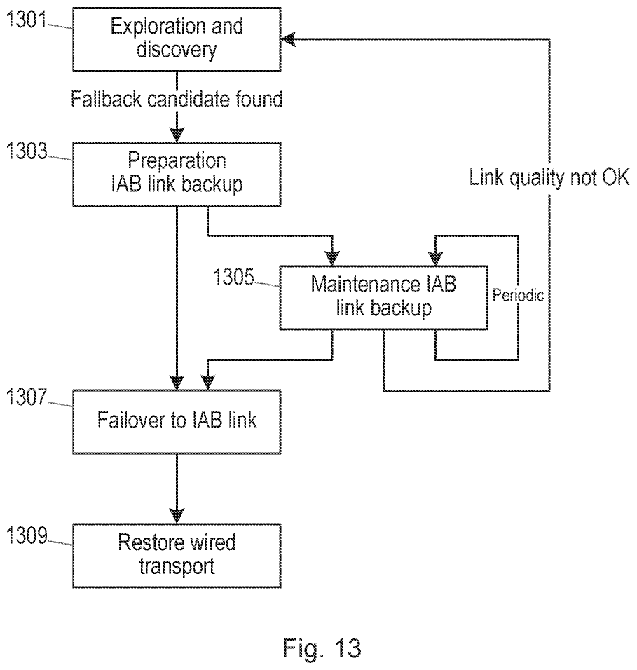

The flow chart in FIG. 13 illustrates a method for enabling fast establishment of IAB connections in the event of a failure in a connection of the TN. Step 1301 is an exploration and discovery step in which IAB link discovery is performed. In this step potential IAB connection candidates are evaluated. This step can comprise performing or determining the optimal or useful radio settings, parameters or configuration for bringing an IAB connection into service, for example as shown in FIG. 12. There may be many different combinations of radio (beam) settings to evaluate, but since step 1301 is performed before any failure occurs in the transport network, there is time to do a substantial evaluation of these different combinations. To perform the exploration and discovery, the DU nodes 812 can be instructed to transmit and/or measure reference signals to/from other DU nodes 812. The reference signals can be transmitted at a certain time, in a particular space (directivity) and with specified frequency resources. The transmission and/or measuring of the reference signals can be coordinated from the CU 810 or from another control node 814 outside the CU-DU network topology. IAB connections with a satisfactory performance (and their radio settings, parameters or configuration) are saved as candidate IAB connections.

In step 1303, IAB connections are prepared. This step can include registration of the IAB-MT at a donor IAB node, configuration of time and frequency resources, and RLC and BAP protocol configuration including routing. In addition, in some embodiments a contention-free Random Access Channel (RACH) configuration may be assigned to the IAB-MT to enable the IAB node to gain fast access to the IAB donor node in the event that IAB fallback is required. All this information may be signalled over the TN relevant connections, either encapsulated in F1 messages or using a separate dedicated protocol.

Once the IAB connections have been prepared, the CU 810 or other control node 814 maintains a “dormant” context for the IAB-MT(s) ready to be activated in case of a failure on a relevant TN connection (i.e. a TN connection where the IAB connection can be used to mitigate the TN failure).

At 1305, if some time has passed since step 1303 was performed, maintenance of the prepared IAB connections can be performed. Thus, to enable satisfactory IAB connection quality in the event of a fault situation, the IAB connection quality can be supervised or evaluated at regular intervals. In the case of a non-satisfactory performance (e.g. the radio conditions are now unfavourable for the IAB connection), the IAB connection can be removed as a fallback candidate, and the procedure can return to step 1301 to repeat the exploration and discovery. It will be appreciated that other candidate IAB connections for which the performance is still satisfactory can be maintained while step 1301 is repeated, or all IAB connections can be discarded and a full exploration and discovery procedure carried out.

At step 1307 a failure occurs on a connection in the TN. In this case, there is a failover to one or more of the IAB connections in place of, or in addition to, the TN connection with the failure. The failure in the TN connection can be a complete failure, i.e. no backhaul data can be sent through the TN connection, or a partial failure, i.e. backhaul data can only be sent in an upstream or downstream direction, or the capacity of the TN connection is reduced below a threshold amount.

The remote DU 812 (i.e. the DU 812 on the peripheral side of the failure) can detect the failure in the TN connection, and wake up the IAB-MT function to request fallback to an IAB connection. Alternatively, the DU that is to be the donor IAB can detect the failure in the TN connection, and send a notification to the potential IAB node that the IAB node should connect to the donor IAB node to request fallback to an IAB connection.

At step 1309, the failed TN connection is restored and so the IAB connection can be dropped or ended in favour of conveying backhaul data via the TN.

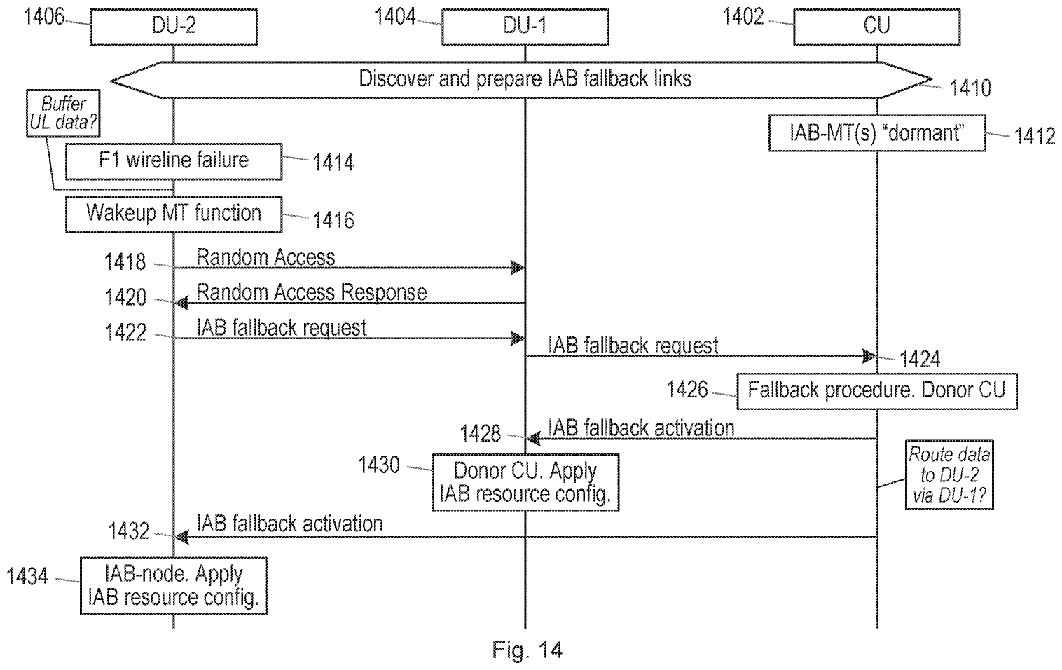

The signalling diagram in FIG. 14 illustrates the IAB failover procedure according to various embodiments. FIG. 14 shows the signalling between a CU 1402 (or other control node), a first DU 1404, DU-1, and a second DU 1406, DU-2. DU-2 1406 is connected to the CU 1402 and the core network via DU-1 1404.

Step 1410 represents the discovery and preparation of IAB connections that can be used as fallback in the event of a failure in the TN. Step 1410 corresponds generally to steps 1301 and 1303 described above. The IAB-MTs are maintained in a dormant state in case of TN connection failure (step 1412).

The remaining parts of the signalling diagram in FIG. 14 relate to implementations of step 1307 in FIG. 13.

At step 1414 a failure occurs in the TN between DU-1 1404 and DU-2 1406. DU-2 1406 therefore wakes up the IAB-MT function (step 1416) and sends a random access request 1418 to DU-1 1404.

DU-1 1404 responds with a Random Access Response 1420, and DU-2 1406 sends an IAB fallback request 1422 to DU-1 1404.

DU-1 1404 forwards the IAB fallback request to the CU 1402 (signal 1424). This triggers the fallback procedure in the CU 1402 (step 1426), and the CU 1402 sends an IAB fallback activation signal 1428 to DU-1 1404 and starts to operate as a donor CU. In response to the IAB fallback activation signal 1428, the DU-1 1404 also starts to operate as a donor DU (step 1430), and the appropriate IAB resource configuration is applied to the IAB connection. This resource configuration was determined during the discovery and preparation stage 1410.

The CU 1402 also sends an IAB fallback activation signal 1432 to DU-2 1406. In response to the IAB fallback activation signal 1432, the DU-2 1406 also starts to operate as an IAB node (step 1434), and the appropriate IAB resource configuration is applied to the IAB connection.

Therefore, backhaul data can be conveyed via the IAB connection between DU-1 1404 and DU-2 1406.

FIG. 15 is a flow chart illustrating a method according to various embodiments performed by a RAN node. To distinguish the RAN node performing the method in FIG. 15 from other RAN nodes in the communication network, the RAN node performing the method is referred to as the ‘first RAN node’. The method in FIG. 15 represents the first RAN node operating as a DU. The first RAN node may perform the method in response to executing suitably formulated computer readable code. The computer readable code may be embodied or stored on a computer readable medium, such as a memory chip, optical disc, or other storage medium. The computer readable medium may be part of a computer program product.

The first RAN node is operating in a TN of a communication network, with the TN being used for conveying backhaul data between multiple RAN nodes (including the first RAN node). The TN can also be used for conveying backhaul data between RAN nodes (including the first RAN node) and a core network of the communication network. TN connections between the plurality of RAN nodes can comprise optical fibres or use radio frequencies different to the radio frequencies used by IAB connections and the wireless devices. Thus, the TN is separate to the radio access network provided by the RAN nodes for use by wireless devices (UEs).

In step 1501, the first RAN node performs a discovery procedure to identify one or more other RAN nodes in the TN with which an IAB connection can be established. Step 1501 can be performed in a similar way to step 1301 described above.

In some embodiments, step 1501 is performed in response to receiving an instruction to perform the discovery procedure from a control node in the communication network. The control node may be a CU or other control node in the communication network. The instruction to perform step 1501 can be received from the control node via the TN.

In some embodiments, step 1501 can comprise transmitting a reference signal for measurement by other RAN nodes. The reference signal may be transmitted according to any one or more of a timing, a directivity, and/or a frequency specified in an instruction to perform the discovery procedure.

Step 1501 may also or alternatively comprise the first RAN node measuring a reference signal transmitted by other RAN nodes. The reference signal may have a timing, a directivity and/or a frequency specified in an instruction to perform the discovery procedure. In these embodiments, step 1501 can comprise identifying the one or more other RAN nodes as a RAN nodes for which the measurement of the reference signal satisfies one or more quality criteria. The quality criteria can be related to a received signal strength or received signal quality, or any other suitable quality measure.

In step 1503, the first RAN node prepares respective configurations for IAB connections with the other RAN nodes identified in step 1501. Step 1503 can be performed in a similar way to step 1303 and FIG. 12 described above.

In some embodiments, step 1503 can comprise any one or more of: registering an IAB-MT; determining a time and/or frequency configuration for the IAB connection; determining a RLC protocol configuration for the IAB connection; determining a BAP configuration for the IAB connection; and determining a RACH configuration for initiating the IAB connection.

In some embodiments, the first RAN node can store information relating to the prepared configuration(s).

In some embodiments, the first RAN node can send information relating to the prepared configuration(s) to a control node. The control node that the prepared configuration(s) are sent to can be a control node for the IAB connection, for example a donor IAB node, or a CU in the TN.

At step 1505, if a failure occurs in a first TN connection of the TN, the first RAN node establishes one or more of the IAB connections according to the prepared configuration. The first TN connection is a TN connection between two RAN nodes. The first RAN node may be one of the two RAN nodes connected to the TN connection that has failed, but this does not have to be the case. Step 1505 can be performed in a similar way to step 1307 and FIG. 14 described above. For instance, in the example shown in FIG. 10 where TN connection 2 has failed, the first RAN node can be any of DU-1, DU-2 or DU-3. In the example shown in FIG. 11 where TN connection 3 has failed, the first RAN node can be any of DU-3, DU-4 or DU-6.

In some embodiments, the first TN connection is between the first RAN node and a second RAN node that is peripheral to the first RAN node in the TN. For example, the first RAN node can be DU-1 in FIG. 10 and the second RAN node can be DU-3. In these embodiments the first RAN node operates as an IAB donor DU for the IAB connection 1002 to the second RAN node. In these embodiments, step 1505 can comprise sending a paging message to the second RAN node to request the second RAN node connect to the first RAN node. In these embodiments, step 1505 can comprise receiving a random access signal from the second RAN node. This random access signal may be received regardless of whether the first RAN node sent a paging message to the second RAN node.

In some embodiments, the first TN connection is between the first RAN node and a second RAN node, with the first RAN node being peripheral to the second RAN node in the TN. For example, the first RAN node can be DU-3 in FIG. 10 and the second RAN node can be DU-1. In these embodiments the second RAN node operates as an IAB donor DU for the IAB connection 1002 to the first RAN node. In these embodiments, step 1505 can comprise receiving a paging message from the second RAN node to request the first RAN node connect to the second RAN node. Step 1505 can comprise sending a random access signal to the second RAN node, for example in response to receiving the paging message, or on detecting the failure in the first TN connection. Thus, the random access signal may be sent regardless of whether the first RAN node received a paging message from the second RAN node.

The failure in the first TN connection may be the first TN connection being unable to convey any backhaul data. Alternatively, the failure in the first TN connection may be the first TN connection being unable to convey at least a threshold amount of backhaul data. Alternatively, the failure in the first TN connection may be the first TN connection only being able to convey less than a threshold amount of backhaul data. Alternatively, the failure in the first TN connection may be an amount of backhaul data to convey exceeding a capacity of the first TN connection for conveying backhaul data.

In some embodiments, the first RAN node can detect whether a failure has occurred in a TN connection. Detection of the failure can occur if backhaul data is no longer successfully conveyed over one or more TN connections in the TN.

In step 1507, the established one or more IAB connections are used in place of, or in addition to, the first TN connection to convey backhaul data in the TN.

If following step 1503 no failure occurs within a predetermined time period of step 1501 being performed and/or step 1503 being performed, steps 1501 and 1503 can be repeated to prepare further configurations for IAB connections between the first RAN node and one or more other RAN nodes. If a failure subsequently occurs, one or more IAB connections can be established according to the further configuration(s).

FIG. 16 is a flow chart illustrating a method according to various embodiments performed by a control node. The control node may be a central unit (CU) in a RAN node, or a CU or other control node separate from a RAN node. The control node may perform the method in response to executing suitably formulated computer readable code. The computer readable code may be embodied or stored on a computer readable medium, such as a memory chip, optical disc, or other storage medium. The computer readable medium may be part of a computer program product.

The control node is operating in communication network, and the communication network has a TN for conveying backhaul data between multiple RAN nodes. The TN can also be used for conveying backhaul data between RAN nodes and a core network of the communication network. TN connections between the plurality of RAN nodes can comprise optical fibres or use radio frequencies different to the radio frequencies used by IAB connections and wireless devices. Thus, the TN is separate to the radio access network provided by the RAN nodes for use by wireless devices (UEs).

In step 1601, the control node initiates a discovery procedure by a first RAN node in the plurality of RAN nodes to identify one or more other RAN nodes with which an IAB connection can be established. In some embodiments, step 1601 is performed by the control node sending an instruction to perform the discovery procedure to the first RAN node and/or the other RAN nodes. The instruction sent in step 1601 can be sent to the RAN nodes via the TN.

In some embodiments, step 1601 can comprise instructing the first RAN node and/or other RAN nodes to transmit a reference signal for measurement by other RAN nodes. The instruction to transmit the reference signal may indicate any one or more of a timing, a directivity, and/or a frequency for the transmission of the reference signal.

Step 1601 may also or alternatively comprise instructing the first RAN node to measure a reference signal transmitted by other RAN nodes. The instruction may indicate a timing, a directivity and/or a frequency with which the reference signal is to be transmitted.

In step 1603, respective configurations for IAB connections between the first RAN node and the identified other RAN nodes are prepared. These configurations are for use in establishing respective IAB connections between the first RAN node and the identified other RAN nodes in the event of a failure in a first TN connection in the TN. Step 1603 can be performed in a similar way to step 1303 and FIG. 12 described above.

In some embodiments, step 1603 can comprise any one or more of: registering an IAB-MT; determining a time and/or frequency configuration for the IAB connection; determining a RLC protocol configuration for the IAB connection; determining a BAP configuration for the IAB connection; and determining a RACH configuration for initiating the IAB connection.

In some embodiments, the control node can store information relating to the prepared configuration(s).

In some embodiments, the control node can receive information relating to the prepared configuration(s) from the first RAN node and/or other RAN nodes.

The failure in the first TN connection may be the first TN connection being unable to convey any backhaul data. Alternatively, the failure in the first TN connection may be the first TN connection being unable to convey at least a threshold amount of backhaul data. Alternatively, the failure in the first TN connection may be the first TN connection only being able to convey less than a threshold amount of backhaul data. Alternatively, the failure in the first TN connection may be an amount of backhaul data to convey exceeding a capacity of the first TN connection for conveying backhaul data.

If following step 1603 no failure occurs within a predetermined time period, steps 1601 and 1603 can be repeated to prepare further configurations for IAB connections between the RAN nodes. If a failure subsequently occurs, one or more IAB connections can be established according to the further configuration(s).

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

What is claimed is:

1-239. (canceled)

240. A method of operating a first radio access network (RAN) node in a transport network (TN) of a communication network, wherein the TN is for conveying backhaul data between a plurality of RAN nodes, wherein the RAN nodes provide a radio access network for wireless devices to use to access the communication network, the method in the first RAN node comprising:
performing a discovery procedure to identify one or more other RAN nodes in the plurality of RAN nodes with which an Integrated Access and Backhaul, IAB, connection can be established;
preparing respective configurations for IAB connections between the first RAN node and the identified one or more other RAN nodes;
if a failure occurs in a first TN connection between two RAN nodes, establishing one or more of the IAB connections according to the respective prepared configuration; and
using the established one or more IAB connections in place of, or in addition to, the first TN connection to convey backhaul data.

241. The method as claimed in claim 240, wherein the step of performing the discovery procedure is performed in response to receiving an instruction to perform the discovery procedure from a control node in the communication network. optionally, wherein the instruction is received from the control node via the TN, further optionally, wherein the step of performing the discovery procedure comprises at least one of:
transmitting a reference signal for measurement by other RAN nodes in the plurality of RAN nodes, optionally wherein the reference signal is transmitted according to any one or more of a timing, a directivity, and/or a frequency specified in an instruction to perform the discovery procedure received from the control node;
measuring a reference signal transmitted by other RAN nodes in the plurality of RAN nodes, optionally wherein the reference signal has a timing, a directivity and/or a frequency specified in an instruction to perform the discovery procedure received from the control node; and
identifying the one or more other RAN nodes as RAN nodes for which the measurement of the reference signal satisfies one or more quality criteria.

242. The method as claimed in claim 240, wherein the step of preparing a configuration for an IAB connection comprises any one or more of: registering an IAB-mobile termination (IAB-MT); determining a time and/or frequency configuration for the IAB connection; determining a radio link control (RLC) protocol configuration for the IAB connection; determining a backhaul adaptation protocol (BAP) configuration for the IAB connection; and determining a random access channel (RACH) configuration for initiating the IAB connection, optionally wherein the method further comprises at least one of:
storing information relating to the one or more prepared configurations; and
sending information relating to the one or more prepared configurations to a control node for the IAB connection.

243. The method as claimed in claim 240, wherein the failure occurs in a first TN connection between the first RAN node and a second RAN node that is peripheral to the first RAN node in the TN, and wherein the first RAN node operates as a donor distributed unit (DU) for an IAB connection to the second RAN node, optionally wherein the step of establishing the IAB connection comprises:
sending a paging message to the second RAN node to request the second RAN node connect to the first RAN node or
receiving a random access signal from the second RAN node.

244. The method as claimed in claim 240, wherein the failure occurs in a first TN connection between the first RAN node and a second RAN node, wherein the first RAN node is peripheral to the second RAN node in the TN, and wherein the second RAN node operates as a donor distributed unit (DU) for an IAB connection to the first RAN node, optionally wherein the step of establishing the IAB connection comprises:
transmitting a random access signal to the second RAN node, optionally wherein the random access signal is transmitted to the second RAN node on detecting the failure in the first TN connection, or on receiving a paging message from the second RAN node that requests the first RAN node to connect to the second RAN node.

245. The method as claimed in claim 240, wherein the method further comprises:
if a failure does not occur within a predetermined time period of the discovery procedure being performed and/or the configurations being prepared, repeating the steps of performing the discovery procedure and preparing a configuration to prepare further configurations for IAB connections between the first RAN node and one or more other RAN nodes, optionally wherein the method further comprises:
if, after repeating the steps of performing the discovery procedure and preparing, a failure occurs in a TN connection of the TN between two RAN nodes, establishing one or more IAB connections according to the respective further configurations; and
using the established second IAB connection to convey backhaul data.

246. The method of operating a control node in a communication network, wherein the communication network comprises a transport network, TN, for conveying backhaul data between a plurality of radio access network, RAN, nodes, wherein the RAN nodes provide a radio access network for wireless devices to use to access the communication network, the method in the control node comprising:
initiating a discovery procedure by at least a first RAN node in the plurality of RAN nodes to identify one or more other RAN nodes in the plurality of RAN nodes with which an Integrated Access and Backhaul, IAB, connection can be established; and
preparing respective configurations for IAB connections between the first RAN node and the identified other RAN nodes, wherein the respective configurations are for use in establishing one or more respective IAB connections between the first RAN node and the identified other RAN nodes in the event of a failure in a first TN connection in the TN.

247. The method as claimed in claim 246, wherein the step of initiating the discovery procedure comprises:
sending an instruction to perform the discovery procedure to the first RAN node, optionally wherein the instruction is sent to the first RAN node via the TN.

248. The method as claimed in claim 247, wherein the instruction to perform the discovery procedure comprises: an instruction to transmit a reference signal with a specific timing, directivity, and/or frequency; and/or an instruction to measure a reference signal from another RAN node with a specific timing, directivity and/or frequency.

249. The method as claimed in claim 246, wherein the method further comprises:
if a failure does not occur within a predetermined time period of the discovery procedure being performed by the first RAN node and/or the configurations being prepared, repeating the steps of initiating the discovery procedure and preparing a configuration to prepare further configurations for IAB connections between the first RAN node and one or more other RAN nodes.

250. The first radio access network (RAN) node configured for use in a transport network (TN) of a communication network, wherein the TN is for conveying backhaul data between a plurality of RAN nodes, wherein the RAN nodes provide a radio access network for wireless devices to use to access the communication network, the first RAN node comprises a processor and a memory, said memory containing instructions executable by said processor whereby said first RAN node is operative to:
perform a discovery procedure to identify one or more other RAN nodes in the plurality of RAN nodes with which an Integrated Access and Backhaul (IAB) connection can be established;
prepare respective configurations for IAB connections between the first RAN node and the identified one or more other RAN nodes;
if a failure occurs in a first TN connection between two RAN nodes, establish one or more of the IAB connections according to the respective prepared configuration; and
use the established one or more IAB connections in place of, or in addition to, the first TN connection to convey backhaul data.

251. The first RAN node as claimed in claim 250, wherein the first RAN node is operative to perform the discovery procedure in response to receiving an instruction to perform the discovery procedure from a control node in the communication network, optionally wherein the instruction is received from the control node via the TN, further optionally wherein the first RAN node is operative to perform the discovery procedure by performing at least one of:
transmitting a reference signal for measurement by other RAN nodes in the plurality of RAN nodes, optionally wherein the reference signal is transmitted according to any one or more of a timing, a directivity, and/or a frequency specified in an instruction to perform the discovery procedure received from the control node;
measuring a reference signal transmitted by other RAN nodes in the plurality of RAN nodes, optionally wherein the reference signal has a timing, a directivity and/or a frequency specified in an instruction to perform the discovery procedure received from the control node; and
identifying the one or more other RAN nodes as RAN nodes for which the measurement of the reference signal satisfies one or more quality criteria.

252. The first RAN node as claimed in claims 250, wherein the failure occurs in a first TN connection between the first RAN node and a second RAN node that is peripheral to the first RAN node in the TN, and wherein the first RAN node operates as a donor distributed unit (DU) for an IAB connection to the second RAN node, optionally wherein the first RAN node is operative to establish the IAB connection by:
sending a paging message to the second RAN node to request the second RAN node connect to the first RAN node or
receiving a random access signal from the second RAN node.

253. The first RAN node as claimed in claim 250, wherein the failure occurs in a first TN connection between the first RAN node and a second RAN node, wherein the first RAN node is peripheral to the second RAN node in the TN, and wherein the second RAN node operates as a donor distributed unit (DU) for an IAB connection to the first RAN node, optionally wherein the first RAN node is operative to establish the IAB connection by:
transmitting a random access signal to the second RAN node, optionally wherein the random access signal is transmitted to the second RAN node on detecting the failure in the first TN connection, or on receiving a paging message from the second RAN node that requests the first RAN node to connect to the second RAN node.

254. The first RAN node as claimed in claim 250, wherein the first RAN node is further operative to:
if a failure does not occur within a predetermined time period of the discovery procedure being performed and/or the configurations being prepared, repeat the discovery procedure and prepare further configurations for IAB connections between the first RAN node and one or more other RAN nodes, optionally wherein the first RAN node is further operative to:
if, after repeating the discovery procedure and preparing further configurations, a failure occurs in a TN connection of the TN between two RAN nodes, establish one or more IAB connections according to the respective further configurations; and
use the established second IAB connection to convey backhaul data.

255. The control node configured for use in a communication network, wherein the communication network comprises a transport network (TN) for conveying backhaul data between a plurality of radio access network (RAN) nodes, wherein the RAN nodes provide a radio access network for wireless devices to use to access the communication network, the control node comprises a processor and a memory, said memory containing instructions executable by said processor whereby said control node is operative to:
initiate a discovery procedure by at least a first RAN node in the plurality of RAN nodes to identify one or more other RAN nodes in the plurality of RAN nodes with which an Integrated Access and Backhaul (IAB) connection can be established; and
prepare respective configurations for IAB connections between the first RAN node and the identified other RAN nodes, wherein the respective configurations are for use in establishing one or more respective IAB connections between the first RAN node and the identified other RAN nodes in the event of a failure in a first TN connection in the TN.

256. The control node as claimed in claim 255, wherein the control node is operative to initiate the discovery procedure by: sending an instruction to perform the discovery procedure to the first RAN node, optionally wherein the instruction is sent to the first RAN node via the TN.

257. The control node as claimed in claim 255, wherein the instruction to perform the discovery procedure comprises an instruction to transmit a reference signal with a specific timing, directivity, and/or frequency; and/or an instruction to measure a reference signal from another RAN node with a specific timing, directivity and/or frequency.

258. The control node as claimed in claim 255, wherein the failure in the first TN connection comprises any of:
the first TN connection being unable to convey any backhaul data;
the first TN connection being unable to convey at least a threshold amount of backhaul data;
the first TN connection only being able to convey less than a threshold amount of backhaul data; and
an amount of backhaul data to convey exceeding a capacity of the first TN connection for conveying backhaul data.

259. The control node as claimed in claim 255, wherein the control node is further operative to:
if a failure does not occur within a predetermined time period of the discovery procedure being performed by the first RAN node and/or the configurations being prepared, repeat the initiation of the discovery procedure and prepare further configurations for IAB connections between the first RAN node and one or more other RAN nodes.
